(19) United States
(12) Patent Application Publication
(10) Pub. No.: US 2004/0249808 A1
(43) Pub. Date: Dec. 9, 2004

(54) Query expansion using query logs

(75) Inventors: Saliha Azzam, Redmond, WA (US); Michael V. Calcagno, Kirkland, WA (US); Kevin W. Humphreys, Redmond, WA (US)

Correspondence Address: Brian D. Kaul, Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/455,995

(22) Filed: Jun. 6, 2003

(51) Int. Cl. G06F 17/30

(52) U.S. Cl. 707/4

(57) ABSTRACT

In a method of processing an input query, an input query is received and a related query is selected from a query log. Next, the selected query is provided to a query processing system in place of the original input query. The present invention is also directed to a query modification system that is configured to perform the above-described method.

### BACKGROUND OF THE INVENTION

The present invention relates to input queries for query processing systems, such as search and question-answer (Q/A) systems, that receive and process input queries. More particularly, the present invention relates to methods of improving the quality of the input query using query logs.

Query processing systems generally provide information to a user in response to an input query. These systems include search systems, Q/A systems, and other systems that process input queries. Search systems, in response to an input query, generally produce search results for the user in the form of documents and passages that are selected based upon a comparison of documents with key words of the input query. Question-answer (Q/A) systems generally operate on queries that are intended to elicit a specific answer. Such systems generally provide additional processing to the search results to narrow the search results to those specific phrases that are likely to contain the answer sought after by the user.

The quality of the search results produced by the query processing system depends on the quality of the input query. In general, the more explicit the query, the greater the likelihood that it will elicit the information or answers sought by the user. For example, some users enter fairly complete queries, such as “When was Albert Einstein born?” It can be determined from such a complete query, that the user is seeking a date. Accordingly, the search results produced by the query processing system in response to the query can be narrowed to those phrases that contain a date.

However, many users submit incomplete or implicit queries, such as key words rather than complete sentences. Such queries contain fewer clues to the type of answer or information that is being sought after by the user. For example, if the submitted query was “Albert Einstein birth” rather than the more explicit query provided above, the query processing system is less likely to determine that the user is seeking a date. As a result, the query processing system will likely return general documents and passages rather than the specific answer sought by the user.

Some query processing systems attempt to improve answer and information retrieval recall through an expansion of key words of the input query. For example, identified key words of an input query can be expanded to include plural and singular forms, synonyms, etc. to ensure that documents containing the expanded terms are also retrieved.

Unfortunately, such query expansion provides little improvement to the quality of the input query when the query is implicit. In other words, an implicit or incomplete input query remains implicit and incomplete following the expansion. As a result, such query expansion can be useful in increasing the quantity of documents returned to the user, but provides little improvement to the quality or precision of the search results.

### SUMMARY OF THE INVENTION

The present invention provides expansion of a user's implicit input query to a more complete form. The submission of the expanded query to a query processing system can provide results that are more precisely targeted to the answers or information sought by the user. One aspect of the present invention is directed to a method of processing an input query. In the method, an input query is received and a more complete, or expanded, query is selected from a query log. The selected query is then provided to a query {processing system in place of the input query.

In accordance with another aspect of the invention, prior to the selection of the query that replaces the input query, related or similar queries in a query log are grouped into clusters. Each cluster can be labeled with a representative query that is representative of the queries contained in the cluster. Then, when an input query is received, one or more clusters are associated with the input query, and a single best-ranked one is selected. Finally, the representative query used to label the selected cluster is used as the replacement query for the input query.

The present invention is also directed to a query modification system that includes a query organizer, a query log manager, a cluster ranking component, and a query selecting component. The query organizer is configured to preprocess queries from a query log into clusters of similar or related queries. Each cluster is labeled with a representative query that relates to the queries contained in the cluster. The query log manager is configured to compare the clusters of queries to a new input query and select candidate clusters that are closely related to the input query. The cluster ranking component is configured to rank the candidate clusters based upon weights given to the representative queries. The query selecting component is configured to select one of the candidate clusters based upon its rank, and produce the representative query of that cluster.

These and other features and benefits will become apparent with a careful review of the following drawings and the corresponding detailed description.

### BRIEF DESCRIPTION OF THE DRAWINGS

FIG. 1 is a block diagram of one exemplary environment in which the present invention can be implemented.

FIG. 2 is a block diagram of a Q/A system in accordance with embodiments of the invention.

FIG. 3 is a flowchart illustrating a method of processing an input query in accordance with embodiments of the invention.

FIG. 4 is a block diagram of a query modification system in accordance with embodiments of the invention.

FIG. 5 is a flowchart illustrating a method of processing an input query in accordance with embodiments of the invention.

FIG. 6 is a block diagram of a Q/A system in accordance with embodiments of the invention.

FIG. 7 is a flowchart illustrating a method of generating an answer extraction template in accordance with embodiments of the invention.

### DETAILED DESCRIPTION OF ILLUSTRATIVE EMBODIMENTS

The present invention generally relates to a query modification system that operates to improve the quality of input queries that are submitted to a query processing system, such as, for example, a question-answer (Q/A) or search system. More specifically, the query modification system of the present invention replaces an implicit or incomplete input query with an explicit or more complete query that is selected from a log of queries. The selected query can then be provided to the query processing system, which performs a function such as information and answer retrieval using the selected query. The improved quality of the selected query is more likely to elicit the specific results from the query processing system that are sought by the user.

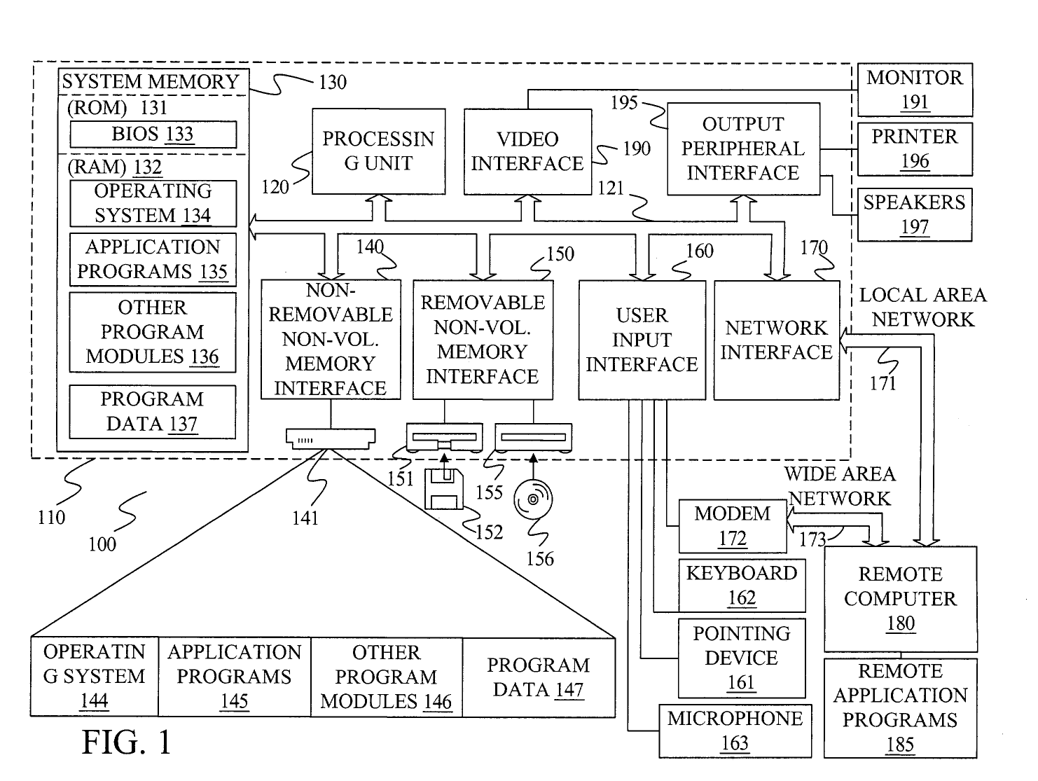

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation,- FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

As noted above, the present invention can be carried out on a computer system such as that described with respect to FIG. 1. Alternatively, the present invention can be carried out on a server, a computer devoted to message handling, or on a distributed system in which different portions of the present invention are carried out on different parts of the distributed computing system.

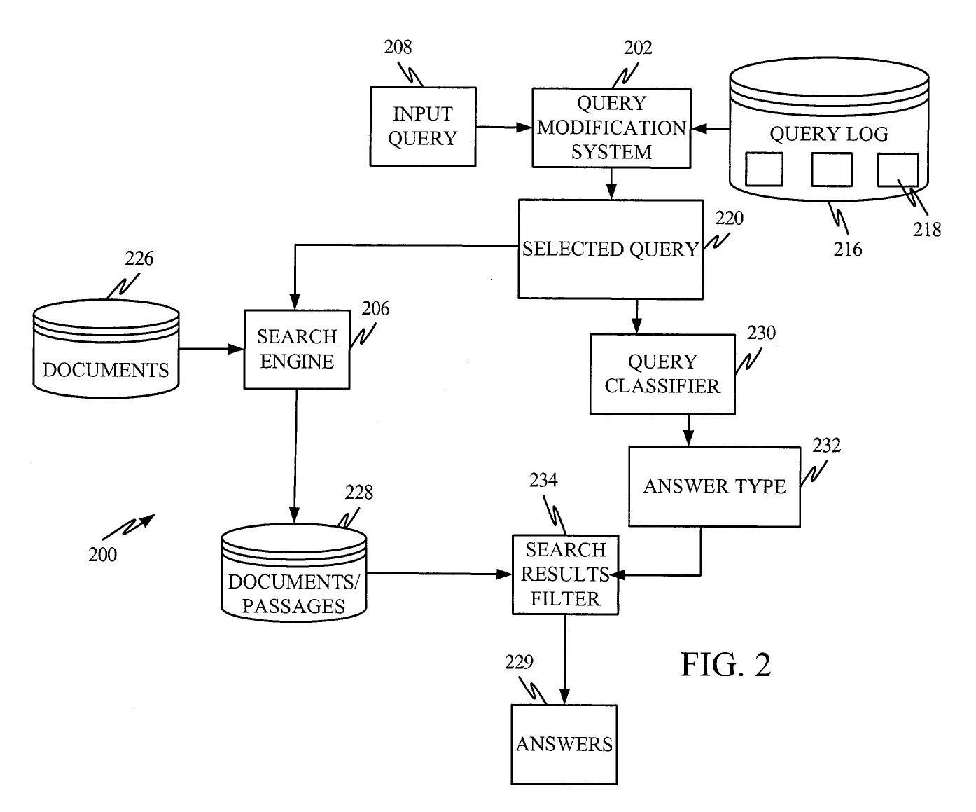

As mentioned above, the present invention generally relates to a query modification system that operates to improve the quality of input queries submitted by users. The query modification system is configured for use with a query processing system, such as a Q/A system, a search system, or other query processing system that is configured to process an input query from a user. FIG. 2 is a block diagram illustrating an example of a query processing system 200, in the form of a Q/A system, that uses a query modification system 202 in accordance with embodiments of the invention. System 200 generally includes, a query classifier 230, and a search engine 206, a query log 216, and a search results filter 234. Input query 208 can be directly from the user or an abstract semantic (e.g., logical) representation of the user's input query that is generated in accordance with known methods.

Query log 216 contains queries 218 that have been previously submitted by users of various search and Q/A systems. Such queries 218 are maintained in a known manner. In the example system 200 of FIG. 2, query log 216 can be produced by search engine 206 or other component. Data associated with queries 218 is also preferably stored in query log 216. The data can include a date and time the query was submitted to system 200, the search results that were provided in response to the query, and data identifying the results that were selected by the user.

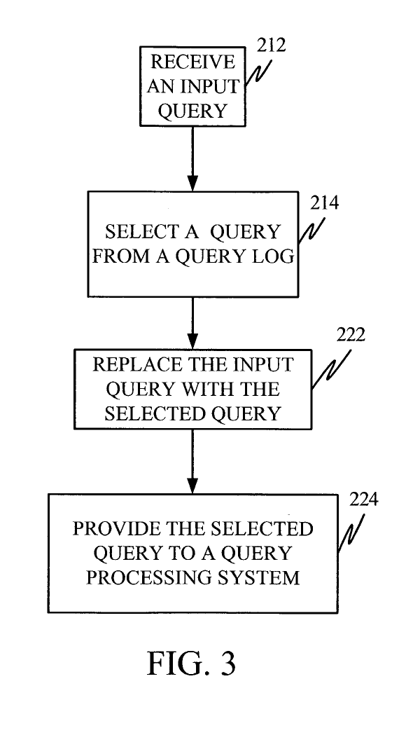

Query modification system 202 is generally configured to perform the method illustrated in the flowchart of FIG. 3. At step 212, query modification system 202 receives the input query 208. Next, at step 214, query modification system 202 selects a query 220 from queries 218 contained in a query log 216, based upon a likelihood that it represents a fuller request that the user may have intended to pose with the original input query 208. The input query 208 is then replaced by the selected query 220 at step 222, which is then provided to query processing system 200, as indicated at step 224.

In the example system 200 of FIG. 2, the selected query 220 is provided to search engine 206 and query classifier 230. Search engine 206 searches documents in database 226 for those that relate to the selected query 220. Related documents and passages are retrieved as search results 228. Search results 228 can be sorted and ranked according to their relevancy and provided to search results filter 234.

Query classifier 230 is generally configured to process complete queries, such as the selected query 220, and determine a query or answer type 232 that identifies a type of answer that is sought by the selected query 220. For example, a selected query 220 of “Who was Benjamin Franklin's wife?” has an answer type 232 of a “person's name”. The answer type 232 identified by query classifier 230 can then be provided to search results filter 234. Search results filter 234 processes the search results 228 to extract candidate phrases or passages that have the same answer type or types 232 that were determined to be associated with selected query 220 by query classifier 230. The extracted candidate phrases or passages having the determined answer type can then be provided to the user as answers 229.

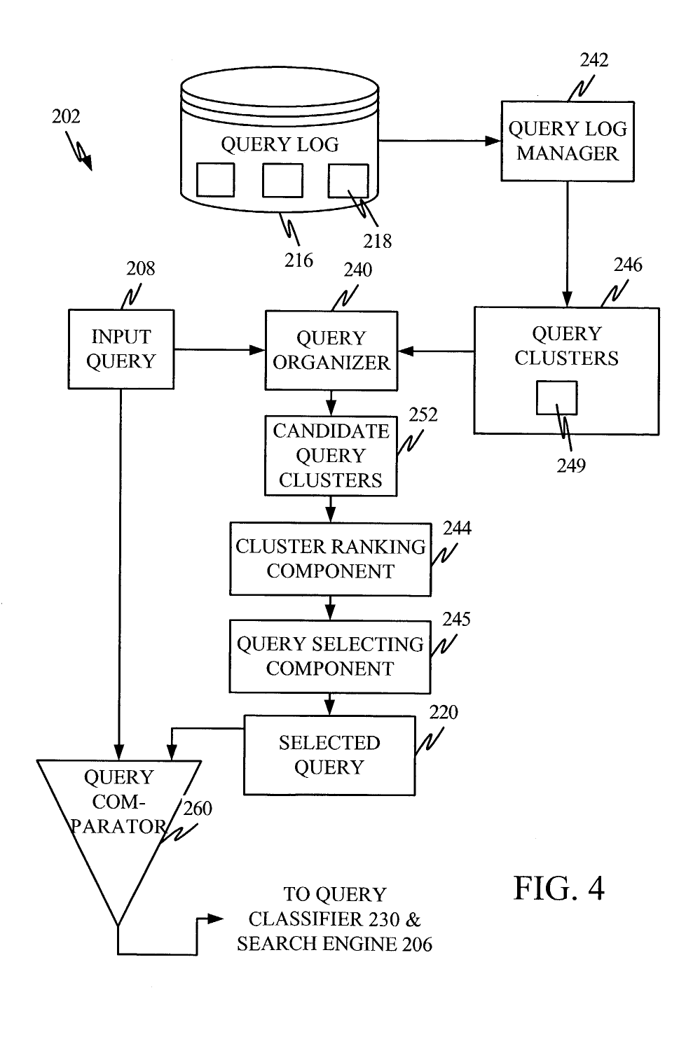

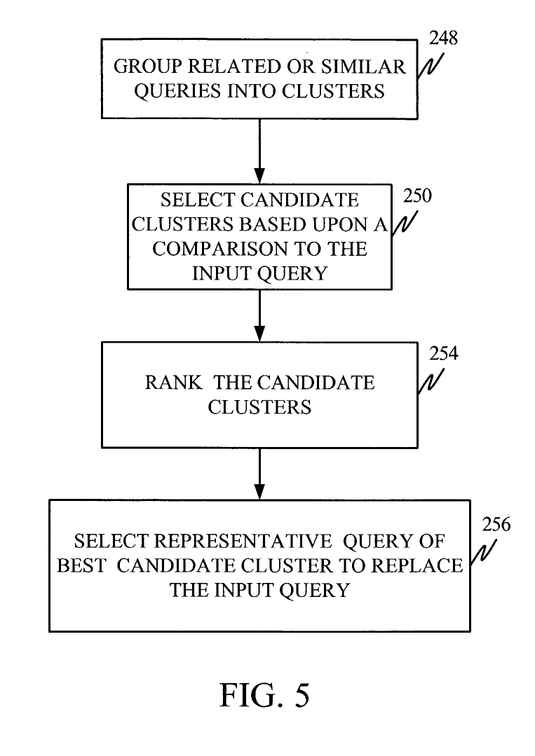

A more detailed discussion of query modification system 202 will be provided with reference to FIGS. 4 and 5. FIG. 4 is a block diagram of a query modification system 202 in accordance with embodiments of the invention. FIG. 5 is a flowchart illustrating a more detailed method of processing an input query 208 that can be performed by query modification system 202.

Query modification system 202 generally includes a query organizer 240, a query log manager 242, a cluster ranking component 244, and a query selecting component 245. In accordance with one embodiment of the invention, query log manager 242 groups related or similar queries 218 into clusters 246, as indicated at step 248 of the method. Various linguistic analyses can be applied to the queries to determine the clusters 246. For example, the grouping of queries 218 into the clusters 246 can, involve comparing the queries at a string level (e.g., comparing key words or significant terms), comparing the queries at a string level following their expansion through lemmatization, comparing semantic types of the queries, comparing logical form, or other abstract semantic representations (e.g. predicate-argument structures) of the queries, and/or comparing other characteristics of the queries. Each of the clusters 246 is preferably labeled with a representative query 249 that relates to the queries 218 contained in the cluster 246. This clustering of the queries 218 preferably occurs off-line. Additionally, it is preferable that this clustering of queries occurs periodically using updated query logs 216 in order to reflect the users' changing interests over time. The clusters 246 are then provided to query organizer 240.

At step 250 of the method, one or more candidate clusters 246 are selected by query organizer 240 based upon a comparison with the input query 208. The linguistic analysis methods described above used to establish the clusters 246 of queries 218, can also be used to perform the comparison of the input query 208 to the clusters 246. In accordance with one embodiment of the invention, candidate clusters 252 are selected based upon their inclusion of significant terms of the input query 208. For example, a representation of an input query “Who is Benjamin Franklin's wife?” could identify “Benjamin Franklin” and “wife” as being significant terms. Accordingly, the selected candidate clusters would consist of clusters 246 of queries 218 that include at least some of the identified significant terms. Preferably, the selected candidate clusters 252 include all of the significant terms of the input query 210.

The candidate clusters 252 can then be ranked by ranking component 244 based upon a weight given to each of the candidate clusters 252 at step 254. Alternatively, only the representative queries 249 of each candidate cluster 252 are ranked by ranking component 244 based upon a weight given to the representative queries 249. Many different factors can be considered in determining the weight given to a cluster. In general, clusters with representative queries 249 that have a predetermined characteristic can be given more weight than those that do not include the predetermined characteristic. For example, clusters with representative queries 249 that include more of the significant terms of the input query 210 can be given more weight than those having fewer. Also, clusters with queries 218 that occur more frequently within the query log are preferably given more weight than those occurring less frequently. Additionally, clusters 218 that were generated from more recent query logs can also be given more weight than those that were generated from earlier query logs. The recency of the query log used to build the clusters, and the frequency of queries within them, is relevant in the weighting process because it can reflect the users' changing interests, such as in response to current events.

In accordance with another embodiment of the invention, the predetermined characteristic is the completeness with which a query 218 or representative query 249 represents a question. This is particularly useful for Q/A systems. This assessment is generally based upon the inclusion of significant query terms in the query 218 or representative query 249. Examples of significant query terms include wh-words like “who”, “when”, “where”, etc. Such terms generally indicate that the query is a complete question, from which a type of answer that is sought by the user can be more easily determined by, for example, query classifier 230 (FIG. 2).

Finally, at step 256 of the method, a representative query 249 is selected by query selecting component 245 based upon its cluster's rank relative to the other clusters 252. The selected query 220 can then be provided to query processing system 200, such as search engine 206 and query classifier 230 of FIG. 2, for further processing.

The answers 229 produced by system 200 in response to the selected query 220 will generally be more specific than those that would have been produced through processing of the original input query 208 that was provided by the user, as a result of the improved quality of the query. However, due to the possibility that the user may input a complete question to Q/A system 200, it may be desirable to compare the selected query 220 to the input query 208 prior to its submission to search engine 206 and query classifier 230. One embodiment of query modification system 202 includes a query comparator 260 to perform such a comparison. Query comparator 260 compares a final ranking of the selected query 220 and the input query 208 based upon a weight assigned to each, such as discussed above with regard to the ranking of candidate clusters 252. Query comparator 260 then provides either the input query 208 or the selected query 220 to the search engine 206 and query classifier 230 depending on which has the highest rank.

Another aspect of the present invention relates to the generation of templates for use by system 200 to provide additional answer extraction assistance for search results filter 234. Templates are generally used in Q/A or Information Extraction (IE) systems to define specific types of information that are desired to be retrieved in response to an input query. For example, a template corresponding to queries about a president, such as “Tell me about Abraham Lincoln”, could includes fields of president number (sixteenth for Lincoln), dates of the presidency, number of terms, etc. Unfortunately, the formation of the template generally requires manually defining each field of the template for each answer type and in every domain.

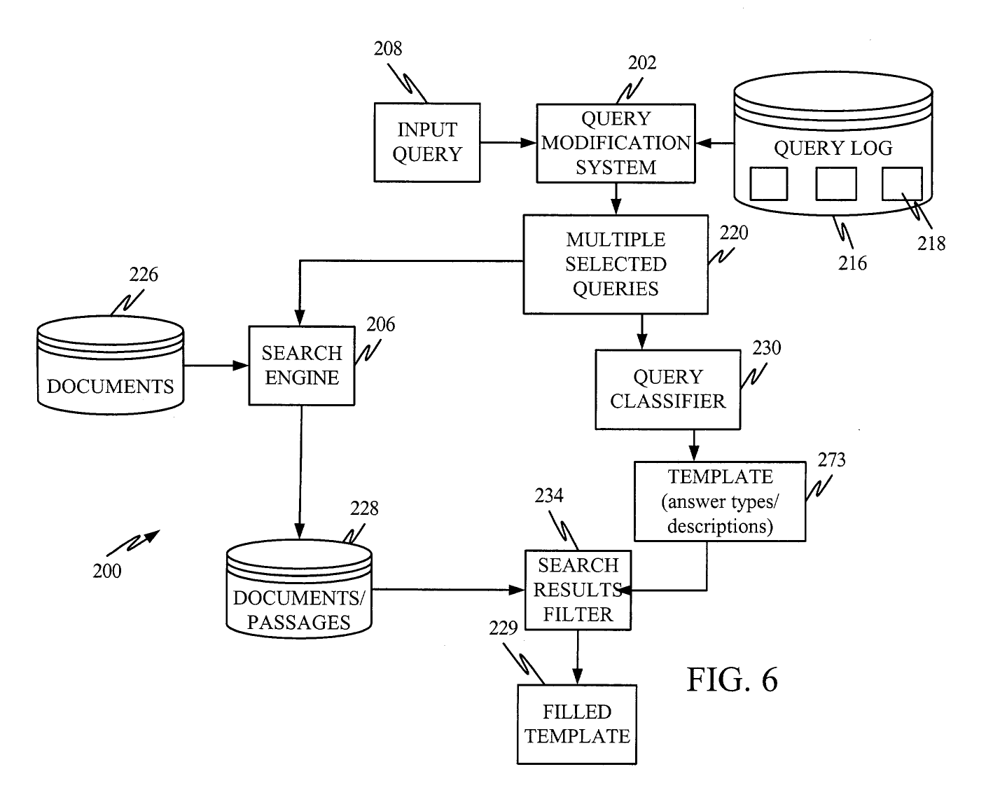

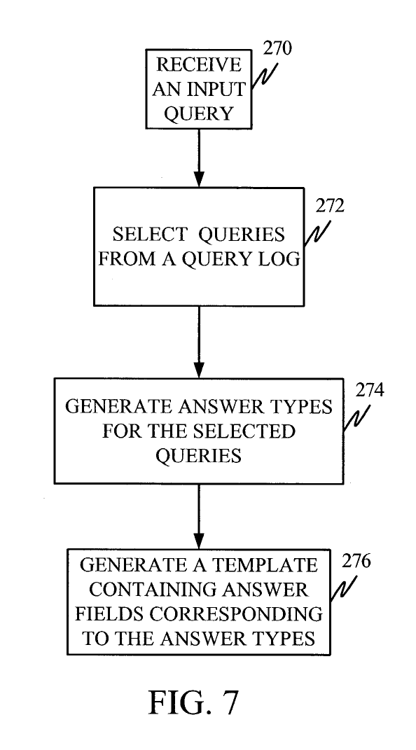

One embodiment of system 200 and query modification system 202, shown in FIGS. 6 and 4, is used to automatically generate a template based upon an input query 208 in accordance with the method illustrated in the flowchart of FIG. 7. At step 270, an input query 208 is received by query modification system 202. Next, at step 272, query modification system 202 is configured to select more than one cluster 246 with representative query 249 (FIG. 4) from query log 216. The process of organizing and selecting the clusters 246 can be conducted as described above, but with the exception that queries from several of the highest ranked or candidate clusters 252 may be output by the query modification system 202. An example of a set of queries 220 that could be output by query modification system 202 in response to an implicit query “Abraham Lincoln” are listed in Table 1.

TABLE 1

| | |
|---|---|
| 1) | Where was Abraham Lincoln assassinated? |
| 2) | Where is Abraham Lincoln buried? |
| 3) | When did Abraham Lincoln die? |
| 4) | When was Abraham Lincoln born? |
| 5) | What year was Abraham Lincoln born? |
| 6) | What was the date of Abraham Lincoln's |
| | birthday? |

The selected queries 220 are provided to query classifier 230 which operates to generate the answer type or types 273 corresponding to each of the selected queries 220, at step 274 of the method. At step 276, the identified answer types 273 are compiled together to form a template that includes fields for all of the answer requirements of the selected queries 220. For example, in response to the exemplary selected queries 220 listed in Table 1, query classifier 230 will identify selected query 2) as pertaining to an answer type of “location”. Additionally, query classifier 230 can eliminate duplicate field entries in the template. Accordingly, only one field of the type “Birth Date” is generated for selected queries 4), 5) and 6), for example. An example of the answer types of the template produced by query classifier 230 in response to the selected queries 220 of Table 1 is provided in Table 2.

TABLE 2
ABRAHAM LINCOLN

Location Death
Location Birth
Death Date
Birth Date

To fill a template, search engine 206 then processes each of the selected queries 220 by searching documents 226 for those that are related, in the same way as it would process individual queries from users. Search engine 206 then provides search results 228 to search results filter 234, which uses the template of answer types 273 from query classifier 230 to analyze search results 228 and extract answers 229 that are likely to satisfy each of the fields or answer requirements of the template. Answers 229 are then provided to the user in the form of a completed template.

Although the present invention has been described with reference to particular embodiments, workers skilled in the art will recognize that changes may be made in form and detail without departing from the spirit and scope of the invention.

What is claimed is:

1. A method of processing an input query comprising steps of:
a) receiving an input query;
b) selecting a query from a query log;
c) replacing the input query with the selected query from the query log; and
d) providing the selected query to a query processing system.

2. The method of claim 1, including grouping related or similar queries of the query log into clusters prior to the selecting step b).

3. The method of claim 2, wherein the grouping step includes comparing the queries at a string level, comparing the queries after lemmatization, comparing semantic types of the queries, or comparing abstract semantic representations of the queries.

4. The method of claim 2, wherein each of the clusters of queries is labeled with a representative query that is representative of the queries contained in the cluster; and the query selected in step b) is one of the representative queries of the clusters.

5. The method of claim 4, wherein the selecting step b) includes:
comparing significant terms of each cluster's representative query to significant terms of the input query;
selecting at least one candidate cluster whose representative query includes all of the significant terms of the input query;
wherein the selected query is the representative query of one of the candidate clusters.

6. The method of claim 4 including ranking the clusters based upon a weight given to their corresponding representative queries.

7. The method of claim 6, wherein representative queries of the clusters representing more complete questions are given more weight than those representing less complete questions.

8. The method of claim 6, wherein clusters generated from more recent query logs are given more weight than clusters generated earlier.

9. The method of claim 6, wherein the representative query is chosen in the selecting step b) based upon its rank.

10. The method of claim 1, wherein the selecting step b) includes comparing significant terms of the queries of the query log to significant terms of the input query.

11. The method of claim 2, wherein the grouping step includes:
comparing significant terms of the queries of the query log;
grouping similar queries into the same cluster;
selecting one of the queries of each cluster as a representative query for the cluster.

12. The method of claim 1 including ranking the queries in the query log based upon a weight given to each processed query, wherein the selected query is chosen in the selecting step b) based upon its rank.

13. The method of claim 12, wherein queries having a predetermined characteristic are given more weight than those lacking the predetermined characteristic.

14. The method of claim 13, wherein the predetermined characteristic is a frequency at which the query or an abstract representation of the query occurs, a completeness with which the query represents a question, or a recency of the query log from which the query was taken.

15. The method of claim 11 including ranking the representative queries of each cluster based upon a weight given to each, wherein the query selected in the selecting step b) is the representative query having the highest rank.

16. The method of claim 15, wherein queries having a higher frequency of occurrence in the cluster are given more weight than those having a lower frequency of occurrence in the cluster.

17. The method of claim 15, wherein queries of the clusters representing more complete questions are given more weight in the cluster than those representing less complete questions.

18. The method of claim 15, wherein the selected query is chosen in the selecting step b) based upon its rank within the candidate cluster and an inclusiveness of the significant terms of the input query.

19. A method of processing an input query comprising:
a) grouping related or similar queries from a query log into clusters;
b) receiving an input query;
c) associating one or more clusters with the input query;
d) selecting a query from an associated cluster or a representative query corresponding to the associated cluster;
e) replacing the input query with the selected query; and
f) providing the selected query to a query processing system.

20. The method of claim 19, wherein the grouping step a) includes comparing the queries at a string level, comparing the queries after lemmatization, comparing semantic types of the queries, or comparing abstract semantic representations of the queries.

21. The method of claim 19, wherein the associating step c) includes:
comparing significant terms of the representative queries to significant terms of the input query; and
selecting one or more candidate clusters each having a representative query that includes all of the significant terms of the input query;
wherein the selected query is one of the representative queries of the candidate clusters.

22. The method of claim 21 including ranking the candidate clusters based upon a weight given to their corresponding representative query, wherein the representative query is chosen in the selecting step d) based upon its rank.

23. The method of claim 22, wherein representative queries of the candidate clusters representing more complete questions are given more weight than those representing less complete questions.

24. The method of claim 22, wherein representative queries corresponding to candidate clusters containing more recent queries are given more weight than those corresponding to candidate clusters containing less recent queries.

25. The method of claim 19, wherein the associating step c) includes:
comparing significant terms of the queries contained in each cluster to significant terms of the input query; and
selecting one or more candidate clusters for association with the input query, each candidate cluster including all of the significant terms of the input query;
wherein the selected query is contained in one of the candidate clusters.

26. The method of claim 25 including ranking the queries in each of the candidate clusters based upon a weight given to each query of the candidate clusters.

27. The method of claim 26, wherein queries having a predetermined characteristic are given more weight than those lacking the predetermined characteristic.

28. The method of claim 27, wherein the predetermined characteristic is a frequency at which the query or a logical representation of the query occurs in the candidate cluster, a completeness at which the query represents a question, or how recent the query was generated.

29. The method of claim 26, wherein queries having a higher frequency of occurrence in the candidate cluster are given more weight than those having a lower frequency of occurrence in the candidate cluster.

30. The method of claim 26, wherein candidate clusters with more complete questions are given more weight than those with less complete questions.

31. The method of claim 25, wherein the selected query is chosen in the selecting step b) based upon its cluster's rank and an inclusiveness of the significant terms of the input query.

32. A query modification system for providing a query to a query processing system in response to an input query, the system comprising:
a query organizer configured to organize queries from a query log into clusters of similar or related queries-, each cluster having a representative query that is representative of the queries contained in the cluster;
a query log manager configured to compare the representative queries to the input query and select candidate representative queries or clusters that are closely related to the input query;
a cluster ranking component configured to rank the candidate clusters or representative queries based upon their similarity to the input query; and
a query selecting component configured to select and provide one of the representative queries of the candidate clusters to the query processing system based on its rank.

33. A method of generating an information extraction template from a query processing system comprising steps of:
a) selecting multiple queries from a query log that relate to an input query;
b) generating a list of answer types and descriptions, each of which correspond to one of the selected queries; and
c) generating an information extraction template containing answer fields and descriptions, each answer field corresponding to one of the answer types in the list.

34. The method of claim 33 including a step b)1) of removing duplicate answer types from the list.

35. The method of claim 33 including a step d) of extracting answers from search results that have answer types that correspond to the answer fields of the template.
